(19) United States
(12) Patent Application Publication
(10) Pub. No.: US 2023/0033144 A1
(43) Pub. Date: Feb. 2, 2023

(54) Five-Pronged Fastener

(71) Applicant: Mary Ellison, Lapeer, MI (US)

(72) Inventor: Mary Ellison, Lapeer, MI (US)

(21) Appl. No.: 17/509,191

(22) Filed: Oct. 25, 2021

Related U.S. Application Data
(60) Provisional application No. 63/226,296, filed on Jul. 28, 2021.

(51) Int. Cl. A44B 1/18; A47C 31/02

(52) U.S. Cl. CPC A44B 1/18; A47C 31/026

(57) ABSTRACT

The present invention relates to a multiple-pronged fastener. The fastener. such as a tack. has a geometrically-shaped or ornamental head, a plurality of prongs extending from the edges or periphery of the head, and one center prong extending from the center of the rear surface of the head. The multiple prongs secure the fastener in position safely while eliminating rotation of the tack along the central axis when applied to the item. The four prongs are preferably triangular, and the center prong is preferably square.

### CROSS-REFERENCE TO RELATED APPLICATION

The present application claims priority to, and the benefit of, U.S. Provisional Application No. 63/226,296, which was filed on Jul. 28, 2021, and is incorporated herein by reference in its entirety.

### FIELD OF THE INVENTION

The present invention relates generally to the field of fasteners. More specifically, the present invention relates to an improved fastener that has four peripheral prongs and one center prong attached to a head of the fastener. The five prongs are inserted into an item such as a piece of upholstered furniture, with a square or round ornamental head abutting the surface of the upholstery or outer finished area. The five prongs provide maximized retention of the fastener in place and secures the item safety while eliminating rotation of the fastener or tack along the central axis when applied to the item. The fastener or tack functions as a way to secure virtually any type of item like upholstery, bulletin boards, posters to a wall, other decorations and adornments. Accordingly, the present disclosure makes specific reference thereto. Nonetheless, it is to be appreciated that aspects of the present invention are also equally applicable to other like applications, devices and methods of manufacture.

### BACKGROUND

By way of background, a fastener such as a tack is a small and sharp broad-headed fastener designed like a nail. A tack generally has a broad head and a single elongated prong that inserts into an item, such as fabric for securing the fabric to a chair or other surface. The head is usually disproportionately wide when compared to the length of the shaft to distribute the force of pushing the prong or pin into the fabric or other material, allowing the hands to be used. Tacks have a lot of applications in everyday life, and for example are used with furniture, art work, upholstery, decorations and other adornments such as decorative trim, ribbons or the like.

Although conventional tacks are functionally useful, but they are not always appropriately secured in the material to which they are applied, and as such may be less effective than the installer anticipates. Further, they need to be readjusted to their desired position regularly. A single prong in current tacks does not provide enough securing power to hold the material in which they are inserted. Even when applying, the single prong tacks can become damaged and specifically, the single prong cannot handle the force applied on the head, and bends or breaks. The conventional tacks fall from their places and need to be repeatedly replaced or readjusted. This causes a lot of frustration to the user, and also is unsafe for the items to which tacks are applied. As an example, a poster secured to a board or a wall may keep falling due to the poor attachment of the conventional single prong tacks.

All these problems are exacerbated when such tacks are used with upholstery, as they can tear the fabrics as well. Such problems can be eliminated or overcome if a tack device exists that provides improved security and retention when attached to an item, and does not depend on a single prong.

Moreover, conventional single prong tacks can easily rotate three hundred and sixty degrees, even when applied to a surface, and can easily move laterally, which is unsafe for both the user and the item, and may detract from the overall appearance of the item with which the tack has been used.

Therefore, there exists a long felt need in the art for an improved fastener that maximizes security when inserted into fabric or other material. There is also a long felt need in the art for an improved fastener that eliminates rotation of the fastener after being applied to an item. Additionally, there is a long felt need in the art for an improved fastener that can be used to secure any type of item like upholstery, bulletin boards, posters and other decorations to a wall and other surfaces. Moreover, there is a long felt need in the art for an improved fastener that can be used for decorative purposes. Further, there is a long felt need in the art for an improved fastener such as a tack with prongs do not bend or break easily when the fastener is applied or inserted into hard material. Furthermore, there is a long felt need in the art for an improved fastener or tack that works like conventional tacks. Finally, there is a long felt need in the art for an improved fastener or tack that easily secures upholstery, leather items, bulletin boards and other decorations and adornments through the use of multiple prongs extending from a head.

The subject matter disclosed and claimed herein, in one embodiment thereof, comprises a five-pronged fastener. The fastener, such as a tack, can be used for securing any type of item like upholstery, fabric, bulletin boards, posters to a wall and other decorations and adornments. More specifically, the fastener or tack has a head, which may include an ornamental shape, four prongs extending from the edges or periphery of the head, and in one embodiment with each prong having an equal length. The prongs are generally triangular with a broader proximal head or end portion attached to the edge or periphery of the head, and a distal pointed end for inserting into the item such as fabric. A fifth central prong extends from center of the rear surface of the head for maximizing security when the tack is inserted into the item.

In this manner, the five-pronged tack of the present invention accomplishes all of the forgoing objectives, and provides users a fastener such as a tack that can have ornamental and other aesthetically pleasing head designs. The fastener, such as a tack, includes a plurality of prongs on the head to maximize security when inserted into an item and utilizes the center prong to prevent against movement around the central axis, thereby keeping the item firm and secure.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a multiple-pronged fastener such as a tack. The fastener is designed to be used for securing any type of item like upholstery, material, fabric, bulletin boards, posters to a wall and other decorations and adornments to various surfaces. More specifically, the fastener has a head, a plurality of prongs extending around the edges or periphery and generally downwardly from the head, wherein each prong has a length and is generally geometrically-shaped with a broader proximal head portion attached to the edge or periphery of the head and a distal pointed end for inserting into the item. A central prong extends from the center of the rear surface of the head for maximizing security and for positioning of the fastener when the tack is inserted into the item. The central prong is generally square, and has a broader proximal square head that is attached to the center of the rear surface and a narrower distal square end that is inserted into the item. The central prong is generally larger that the prongs disposed around the periphery and is approximately twice as large as the prongs around the periphery.

In yet another embodiment, the head can be square or round or any other geometrical shape. When the head is square, walls may be included which extend from the head and downwardly from the head and from each corner of the walls, one of the plurality of prongs is extended.

In yet another embodiment, the head has a concave-shaped rear or interior surface that allows the center prong to be positioned in the groove, and therefore the length of the center prong is longer than the other plurality of prongs for pointing ends to be at the same level.

In yet another embodiment of the present invention, a decorative and secure tack fastener is disclosed. The tack fastener includes a decorative round or square head, four prongs extending from the periphery of the head and a center prong extending from the center of the head. The five prongs extend in a direction away from the upper surface of the head and insert into an item, such as upholstery, fabric or other material, with the head abutting the surface of the item in which the tack or fastener is inserted.

In yet another embodiment of the present invention, a decorative tack for securing upholstery, fabric or other material is disclosed. The decorative tack includes a tack head having an upper surface and a lower surface. The head has a slanted periphery, making the head a concave-shaped head, multiple elongated prongs extend from periphery of the head and a central prong extends from the center of the rear surface of the concave head. The plurality of elongated prongs are generally triangular in shape, and can also have a slight curve along the elongated length. The center prong has a square shape, and is longer in length than the plurality of elongated prongs, and in one embodiment is thicker.

In yet another embodiment of the present invention, the tack head has a round or square shape. Further, each of the plurality of prongs is placed in pairs of diametrically opposite prongs. All of the plurality of prongs are equal in length and shape, and are easily inserted using distal, pointed ends.

In yet another embodiment of the present invention, the tack heads are available in packs of 50, 100, 200 and 500 square head multiple-pronged tacks, and also in packs of 50, 100, 200 and 500 round head multiple-pronged tacks.

In yet another embodiment, the tacks can be inserted into an item by pressing the head through the application applied by the fingers, or by using a tack hammer or other driver. The tacks can be available in French natural, bronze, antique, pewter, black pearl, nickel, brass, stainless steel and other finishes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1A illustrates a bottom perspective view of one potential embodiment of the multiple-pronged tack of the present invention in accordance with the disclosed architecture;

FIG. 1B illustrates a top perspective view of one potential embodiment of the multiple-pronged tack of the present invention in accordance with the disclosed architecture;

FIG. 2 illustrates a bottom perspective view of another potential embodiment of the multiple-pronged tack of the present invention in accordance with the disclosed architecture;

FIG. 3 illustrates a planar view of holes or openings in an item caused when the multiple-pronged tack of the present invention is inserted into the item in accordance with the disclosed architecture;

FIG. 4 illustrates a perspective view of the headed tacks and the round head tacks of one potential embodiment of the multiple-pronged tack of the present invention used for securely holding upholstery in accordance with the disclosed architecture;

FIG. 5A illustrates a planar view of a corner spiked prong of one potential embodiment of the multiple-pronged tack of the present invention in accordance with the disclosed architecture;

FIG. 5B illustrates a planar view of a central prong of one potential embodiment of the multiple-pronged tack of the present invention in accordance with the disclosed architecture; and

FIG. 6 illustrates a side perspective view of a desired surface with one potential embodiment of the square head multiple-pronged tack of the present invention inserted into the desired surface in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved tack device that maximizes security when inserted into an item. There is also a long felt need in the art for an improved tack device that eliminates its rotation or shifting after being applied to an item. Additionally, there is a long felt need in the art for an improved fastener, such as a tack, that can be used to secure any type of item like upholstery, material, fabric, bulletin boards or posters to a wall, and other decorations and adornments. Moreover, there is a long felt need in the art for an improved fastener such as a tack that can be used for decorative purposes. Further, there is a long felt need in the art for an improved fastener such as a tack whose prongs or attachment elements do not bend or break easily when the fastener or tack is applied. Furthermore, there is a long felt need in the art for an improved fastener, such as a tack, that works like conventional fasteners. Finally, there is a long felt need in the art for an improved fastener, such as a tack, that easily secures upholstery, leather items, fabric, material bulletin boards and other decorations or adornments with multiple prongs.

The present invention, in one exemplary embodiment, is a decorative and secure fastener such as a tack fastener. The tack fastener includes a decorative head, a plurality of prongs extending downwardly from the periphery of the head and a center prong extending downwardly from the center of the head. The plurality of prongs extend in a direction away from the upper surface of the head and inserts into an item such as upholstery or fabric with the head abutting the surface of the item in which the fastener is inserted. The prongs are generally triangular, and the center prong is generally square in shape.

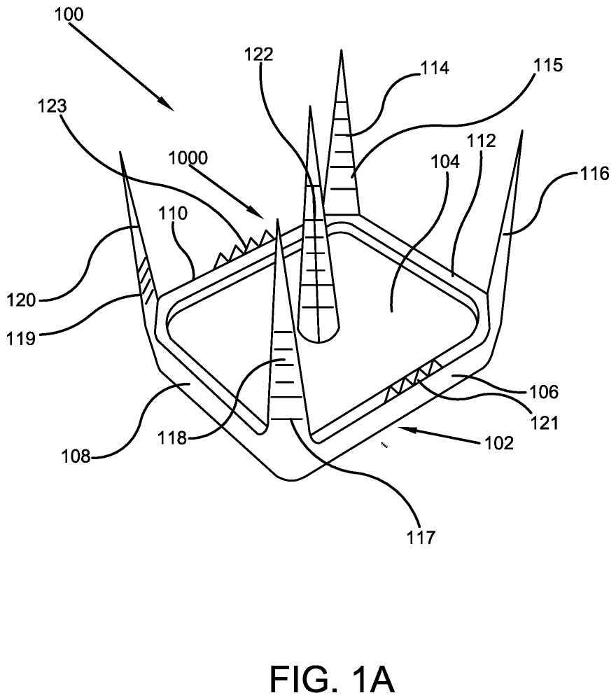

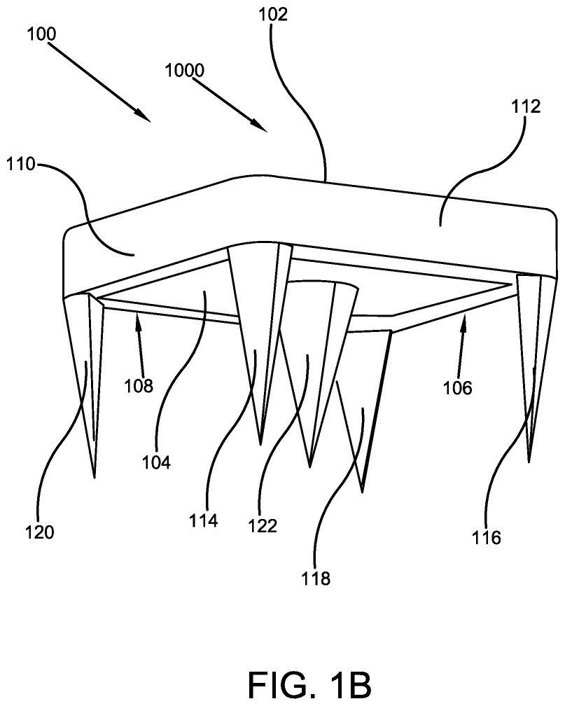

Referring initially to the drawings, FIG. 1A illustrates a bottom perspective view of one potential embodiment of the multiple-pronged fastener such as a tack of the present invention in accordance with the disclosed specification. The multiple-pronged tack of the present embodiment is a multiple-pronged square head tack 100. The multiple-pronged square head tack 100 is designed to have a geometrically-shaped head 1000 that has an upper surface 102 and a lower surface 104. The head 1000 has walls extending generally downwardly from the square head 1000. As shown, the walls 106, 108, 110, 112 extend generally downwardly towards the lower surface 104 (away from the upper surface 102) from edges of the square head 1000. Preferably, the square head 1000 can be 14 mm×14 mm. The square head 1000 can have each edge in the range 9 mm-30 mm. Each wall 106, 108, 110, 112 can have a height in the range 2 mm-10 mm. At the corners of the walls, the decorative and secure tack fastener 100 has a spiked prong that is used for inserting the tack 100 into any desired surface to maximize security of the item such as upholstery, leather items, bulletin boards and much more. One or more of the prongs 114, 116, 118, 120 and 122 may have gripping grooves 115, 117, 119 to help in holding the prongs in the material. The gripping grooves 115, 117 and 119 may extend completely around the surface of the prongs, or alternatively may only have the grooves extending partially around the surface and maybe applied variably to the surface of the prongs. One or more of the side walls 106, 108, 110, 112 may have serrated or other gripping edges 121 and 123 to hold the walls and tack in position.

A first spiked prong 114 extends vertically at the intersection of the third wall 110 and the fourth wall 112. A second spiked prong 116 extends vertically at the intersection of the fourth wall 112 and the first wall 106. A third spiked prong 118 extends vertically at the intersection of the second wall 108 and the first wall 106. A fourth spiked prong 120 extends vertically at the intersection of the second wall 108 and the third wall 110. Each spiked prong 114, 116, 118, 120 has the same length of preferably 14 mm, and has a pointed end for easy insertion into an item such as upholstery or fabric. From the center of the lower surface 104, a central spiked prong 122 extends generally downwardly for providing additional support to the tack 100 when inserted to secure an item. The central spiked prong 122 is used to ensure that there is no rotational or lateral movement of the tack 100, thus keeping an item firmly secured. The head 1000 is sturdy and has a smooth and soft upper surface 102 that allows a user to press or push the tack 100 even with the fingers and without using any tools, even when used on slightly harder surfaces.

When the decorative and secure tack fastener 100 is used for securing an item, all of the spiked prongs 114, 116, 118, 120, 122 are inserted into the item simultaneously, allowing a stronger attachment with maximized security. The corner spikes 114, 116, 118, 120 are tapered in design with pointed ends, and the central spike 122 is preferably square in shape, and is located in between the other prongs. The central prong in one embodiment is longer than the other prongs extending from the head.

FIG. 1B illustrates a top-side perspective view of the one potential embodiment of the multiple-pronged head tack 100 of the present invention in accordance with the disclosed specification. The top surface 102 of the head 1000 is used for applying force to insert the tack 100 into an item. The walls 106, 108, 110, 112 allow the corner spiked prongs 114, 116, 118, 120 to be positioned vertically below the central spiked prong 122 that is located at the center of the rear surface 104 of the square head 1000. The length of the central spiked prong 122 can be slightly longer than the length of the corner prongs allowing the pointing ends of each spiked prong at the same level, thereby enabling a uniform and secure fit within an item. The width of the central prong 122 may also be up to twice as much as the width of the other prongs. Further, the walls extending from the base can be vertically extending from the head or can be slightly slanted. The slanting walls provide a smooth finish to the five-pronged square head tack 100.

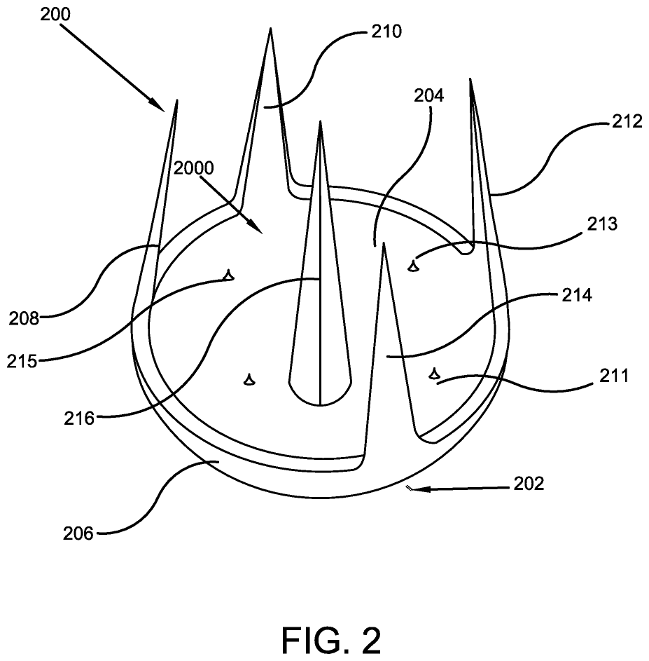

FIG. 2 illustrates a bottom perspective view of another potential embodiment of the multiple-pronged tack of the present invention in accordance with the disclosed specification. The multiple-pronged tack of the present embodiment is a five-pronged round head tack 200. The five-pronged round tack 200 is designed to have a round head 2000 that has an upper surface 202 and a lower surface 204. The round head 2000 has a concave-shaped lower surface 204 and has a rounded periphery 206 that slants down from the round head 2000. Four spiked prongs 208, 210, 212, 214 with pointed ends are disposed on the rounded periphery 206 in two pairs wherein each pair contains diametrically opposite spiked prongs. As shown, a first spiked prong 208 and a third spiked prong 212 are diametrically-opposite to each other and a second spiked prong 210 and a fourth spiked prong 214 are diametrically-opposite to each other. These spiked prongs 208, 210, 212, 214 are of the same dimensions and have a pointed end, thereby allowing the round head tack 200 to easily insert into an item. A central spiked prong 216 is located at the center of the rear surface 204 of the tack 200 that provides additional support and maximizes security of the tack 200 when inserted into an item. The lower surface 204 may also have a number of spikes 211, 213, 215 which can be used to help hold the head of the tack in position on the item to which it has been applied.

The round head 202 can have a diameter in the range 9 mm-30 mm. Further, each spiked prong can have a length in the range 10 mm-40 mm and the central prong 216 can have a length in the range 15 mm-45 mm.

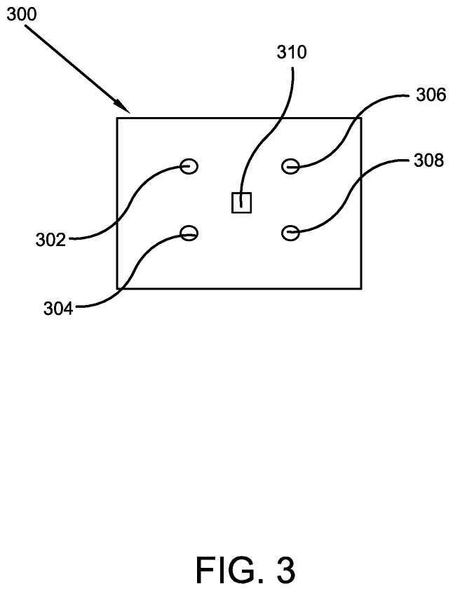

FIG. 3 illustrates a planar view showing holes created in an item caused when the multiple-pronged tack 100, 200 of the present invention is inserted into an item in accordance with the disclosed specification. When the multiple-pronged tack of various embodiments of the present invention is used for securing an item like upholstery, fabric, material, bulletin boards or posters to a wall, the prongs at the edges or corners and the central prong is inserted into the desired surface 300. The multiple prongs provide additional support and maximize security. The support and positioning can be further secured by the pins, gripping edges and grooves in the base, edges and prongs, respectively. The prongs are thin and sturdy, and provide a secure attachment to the desired surface 300. Further, the prongs, when inserted the surface 300, create four tiny circular holes, wherein each hole is created by a peripheral/edged/cornered spiked prong and a central square hole is created by the central prong. As shown, the central square 310 is created by the central prong of the tack 100, 200 and the corner holes 302, 304, 306, 308 are created by peripheral/edged/cornered spiked prongs.

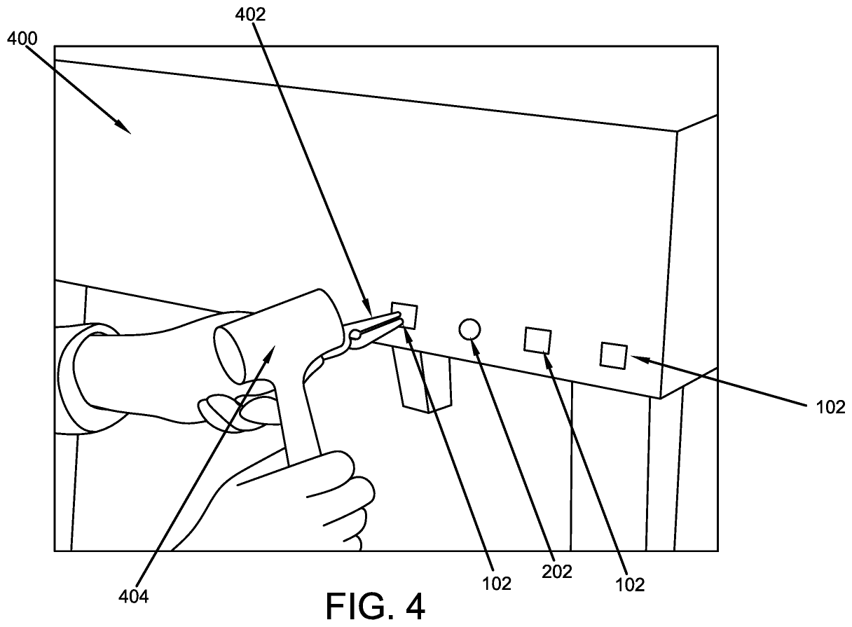

FIG. 4 illustrates a perspective view showing the square head tacks 100 and the round head tacks 200 of the present invention used for securely holding upholstery to a piece of furniture in accordance with the disclosed architecture. As stated earlier, the tacks 100, 200 are used for securing upholstery 400, leather items, bulletin boards, fabric, material and other directions or adornments. As shown, the square head tacks are inserted into the upholstery 400 with the square head 102 visible from outside. Similarly, when round head tacks are inserted into the upholstery 400, the round base 202 is visible from outside. The multiple spiked prongs are easily inserted into the upholstery 400. The tacks are hard, sturdy and can be used with a lightweight (tack) hammer 404, and can also be plucked easily using a small hand tool 402. The tacks can be used in any orientation and virtually on any surface ranging from extremely soft and to extremely hard. It should be appreciated that multiple prongs provide a stable and secure connection and the tacks do not leave their place easily after a long time.

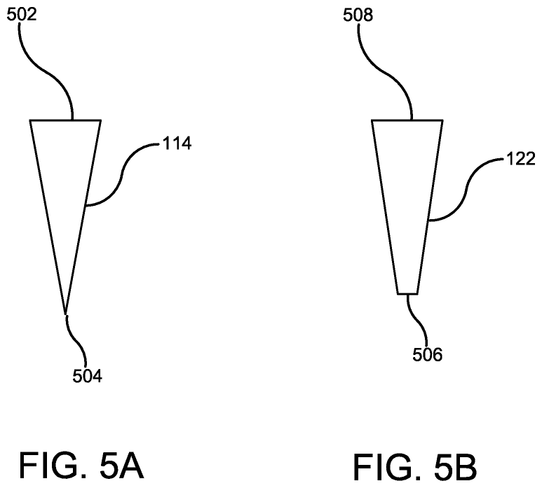

FIGS. 5A and 5B illustrate a planar view of a corner spiked prong and central prong, respectively, of the square or round head tack of the present invention in accordance with the disclosed specification. Each novel tack of the present invention has five spiked prongs extending from the head. The four spikes are at the periphery or at the edges, and a central spike is at the center of the head. The five spiked prongs maximize security when inserted into an item. As shown in FIG. 5A, the corner or edge spiked prong 114 has a substantially triangular shape, having a broader proximal head portion 502 that is connected to the head of the tack. The distal pointed end 504 is used for inserting into an item and even a small force can penetrate the edge prong 114 into the item. It should be appreciated that although the corner spiked prong is explained using the first spiked prong 114 as an example, but all the corner or edge spiked prongs have the same triangular shape with a broader proximal head portion and a distal pointed end.

As shown in FIG. 5B, the central spike 122 is preferably square in shape at the proximal head portion 508 and has a square or truncated distal end 506. The square or truncated distal end 506 is easy to insert into an item and further provides additional stability by preventing any lateral or rotational movement of the track. The square or truncated distal end 506 provides a strong bond inside the item and the square distal end 506 allows a user to use the head of the tack to apply force easily, without breaking the corner spiked prongs.

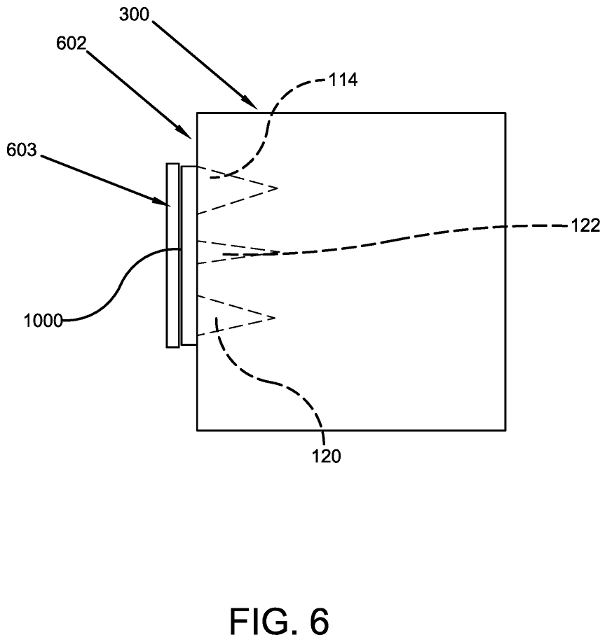

FIG. 6 illustrates a side perspective of a desired surface 300 with the square head five-pronged tack 100 of the present invention inserted into the desired surface 300 in accordance with the disclosed architecture. As shown, at the edge 602 of the desired surface 300 is the square head five-pronged tack 100. When the tack 100 is inserted, the square head 1000 remains outside the edge 602, and is accessible for removing the tack 100. Further, the edge prongs 114, 120, the other two prongs (116, 118) and the center prong 122 are inserted into the surface 300 for maximizing security. The tack 100 functions as a way to virtually secure any type of item like upholstery, bulletin boards, posters to a wall and much more. The head may be provided with a decorative finish 603, or a padded surface to allow cushioning when using one's fingers to press the tack into the surface.

The tacks of various embodiments of the present invention are available in French natural, bronze, antique, pewter, black pearl, nickel, brass, stainless steel and other materials. In one embodiment, a gem or a solitaire can be attached to the upper surface of the square or round heads.

The various tacks of FIGS. 1A through 2 are exemplary, with it being understood that a myriad of additional configurations having various decorative or ornamental elements, shapes, sizes, materials, etc. are within the scope of the present invention. Further, the tack head and the multiple prongs are molded together to form a single unitary structure. Additionally, the center prong and four periphery prongs can be of any shape or length desires or suitable for a particular use. Also, the tack may further comprise hooks or barbs in the prongs that bite into the surface to which the tack in inserted, and can be curved inward or studded for added security and hold according to the usage to which they are applied.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “square head five-pronged tack,” “decorative and secure tack fastener,” “round head five-pronged tack,” “five-pronged tack,” and “ornamental five-pronged tack,” are interchangeable and refer to the five-pronged tack 100, 200 of the present invention.

Notwithstanding the forgoing, the five-pronged tack 100, 200 of the present invention can be of any suitable size and configuration as is known in the art without affecting the overall concept of the invention, provided that it accomplishes the above-stated objectives. One of ordinary skill in the art will appreciate that the size, configuration, and material of the five-pronged tack 100, 200 as shown in the FIGS. are for illustrative purposes only, and that many other sizes and shapes of the five-pronged tack 100, 200 are well within the scope of the present disclosure. Although the dimensions of the five-pronged tack 100, 200 are important design parameters for user convenience, the five-pronged tack 100, 200 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A fastener comprising:
a head having an inner surface, an outer surface and a perimeter;
a prong disposed centrally of the head and provided on the inner surface of the head; and
a plurality of prongs disposed on the perimeter of the head and provided on the inner surface of the head, wherein each of the plurality of prongs is spaced apart from the central prong, and further wherein the plurality of prongs are equally spaced apart from one another.

2. The fastener as recited in claim 1, wherein the plurality of prongs comprise two pairs of prongs and each of the two pairs of prongs are spaced at points equally distant around the perimeter of the head.

3. The fastener as recited in claim 1, wherein the central prong is longer than each of the plurality of prongs.

4. The fastener as recited in claim 3, wherein the central prong is comprised of a head portion and a distal portion, and further wherein the head portion is larger than the distal portion.

5. The fastener as recited in claim 4, wherein the central prong is comprised of a truncated distal portion.

6. The fastener as recited in claim 1, wherein the head further comprises a wall extending about the perimeter.

7. The fastener as recited in claim 6, wherein the plurality of prongs are placed on the wall extending about the perimeter.

8. The fastener as recited in claim 1, wherein each of the plurality of prongs tapers from a head portion to a distal portion.

9. The fastener as recited in claim 6, wherein the wall comprises a serrated edge for holding the head in contact with a surface.

10. The fastener as recited in claim 1, wherein at least one of the central prong and the plurality of prongs comprises grooves for holding the at least one of the central prong and the plurality of prongs in a desired position.

11. The fastener as recited in claim 10, wherein each of the plurality of prongs comprises groves for holding the plurality of prongs in the desired position.

12. A tack comprising:
a shaped head comprising an inner surface, an outer surface and a periphery;
a plurality of prongs extending outwardly from the inner surface, wherein the plurality of prongs comprises a central prong disposed centrally of the inner surface, and further wherein at least a portion of the plurality of prongs are disposed on the periphery of the shaped head; and
a wall positioned along the periphery and extending perpendicularly away from the shaped head.

13. The tack as recited in claim 12, wherein the portion of the plurality of prongs are disposed on the wall around the periphery of the shaped head.

14. The tack as recited in claim 12, wherein the central prong is longer than each of the portion of the plurality of prongs.

15. The tack as recited in claim 14, wherein the central prong is comprised of a head end and a distal end, and further wherein the head end is larger than the distal end and the distal end is truncated.

16. The tack as recited in claim 12, wherein the shaped head comprises at least one of a geometric shape and an ornamental shape.

17. The tack as recited in claim 12, wherein the wall comprises a serrated portion and at least one of the plurality of prongs comprises a groove, and further wherein the serrated portion and the groove are used to hold the tack in a desired position relative to an object to which the tack is removably attached.

18. The tack as recited in claim 12, wherein the shaped head comprises at least one of a decorative surface and a padded surface.

19. A tack comprising:
a head having an interior surface, an exterior surface and a periphery;
a central prong disposed centrally of the interior surface and having a head portion and a distal portion, wherein the head portion is larger than the distal portion and the distal portion is truncated;
two pairs of prongs disposed about the periphery of the head and on the interior surface of the head, wherein the two pair of prongs taper from a head end to a distal end; and
a wall extending about the periphery of the head, wherein the two pairs of prongs are positioned at equal distances around the periphery.

20. The tack as recited in claim 19, wherein the wall comprises a serrated portion and at least some of the plurality of prongs comprise a gripping groove to help hold the tack in a desired position relative to an object to which the tack is removably attached.
